(19) United States
(12) Patent Application Publication
(10) Pub. No.: US 2025/0306446 A1
(43) Pub. Date: Oct. 2, 2025

(54) ILLUMINATION SYSTEM AND PROJECTION DEVICE

(71) Applicant: Coretronic Corporation, Hsin-Chu (TW)

(72) Inventors: Yan-Wen LIN, Hsin-Chu (TW); Yu-Peng CHEN, Hsin-Chu (TW); Hung-Pin CHEN, Hsin-Chu (TW); Wen-Chieh CHUNG, Hsin-Chu (TW); Wen-Chun WANG, Hsin-Chu (TW)

(21) Appl. No.: 19/086,148

(22) Filed: Mar. 21, 2025

(30) Foreign Application Priority Data
Mar. 26, 2024 (CN) 2024103525876

(51) Int. Cl. G03B 21/20

(52) U.S. Cl. CPC G03B 21/2066; G03B 21/208

(57) ABSTRACT

An illumination system and a projection device including the illumination system are disclosed. The illumination system includes a light source, a first turning prism, a second prism, and a light homogenizing element. The light source is configured to generate a light beam. The first turning prism is disposed on the travel path of the light beam. The second turning prism is disposed on the travel path of the light beam from the first turning prism and guides the light beam with the first turning prism. The light homogenizing element is disposed between the first turning prism and the second turning prism and homogenizes the light beam. By the aforementioned configuration, the light path of the illumination system is shortened, and the light uniformity of the light beam is ensured. Based on the advantages of the illumination system, the projection device achieves the objective of reducing volume of a micro projector.

### CROSS REFERENCE TO RELATED APPLICATION

This application claims the priority benefit of Chinese Patent Application Serial Number 2024103525876, filed on Mar. 26, 2024, the full disclosure of which is incorporated herein by reference.

### BACKGROUND

### Technical Field

The present disclosure is related to the technical field of light projection and is particularly related to an illumination device and a projection device.

### Related Art

As solid-state light sources and light projection technology develop, projectors can be seen everywhere in a daily life. In order to meet requirements of thin, light and compact electronic products, the projectors start to be prone to a trend of miniaturization, and the number of the micro projectors daily increases.

The current micro projector usually utilizes a plurality of lenses and a reflector to direct a projection light path. However, because the optical characteristics of the plurality of lenses are different from each other, the particular interval between the two adjacent lenses needs setting according to the optical characteristic of the respective lenses, and the particular interval between the reflector and the lens adjacent to the reflector needs setting, and the corresponding particular intervals of the plurality of lenses are different from each other. The aforementioned configuration of the particular intervals of the plurality of lenses and the reflector results in the excessively large volume of the micro projector and the higher sensitivity of the assembly tolerances of the micro projector, and the configuration of the plurality of lenses causes the manufacturing cost of the micro projector to increase.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one, one part or all of the objectives, the illumination system in one embodiment of the present disclosure includes a light source, a first turning prism, a second prism, and a light homogenizing element. The light source generates a light beam. The first turning prism is disposed on the travel path of the light beam. The second turning prism is disposed on the travel path of the light beam from the first turning prism and guides the light beam with the first turning prism. The light homogenizing element is disposed between the first turning prism and the second turning prism and homogenizes the light beam.

In order to achieve one, one part or all of the objectives, the projection device in one embodiment of the present disclosure includes an illumination system, a TIR prism, a light valve, and a projection lens. The illumination system includes a light source, a first turning prism, a second prism, and a light homogenizing element. The light source generates a light beam. The first turning prism disposed on the travel path of the light beam. The second turning prism is disposed on the travel path of the light beam from the first turning prism and guides the light beam with the first turning prism. The light homogenizing element is disposed between the first turning prism and the second turning prism and homogenizes the light beam. The TIR prism is disposed on the travel path of the light beam from the second turning prism and forms an illumination light beam. The light valve is disposed on the travel path of the illumination light beam and converts the illumination light beam into an image light beam. The projection lens is disposed on the travel path of the image light beam.

### BRIEF DESCRIPTION OF THE DRAWINGS

FIG. 1 depicts a configuration diagram of an illumination system according to one embodiment of the present disclosure.

FIG. 2 depicts a configuration diagram of a projection device according to one embodiment of the present disclosure.

FIG. 3 depicts a configuration diagram of a projection device according to another embodiment of the present disclosure.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

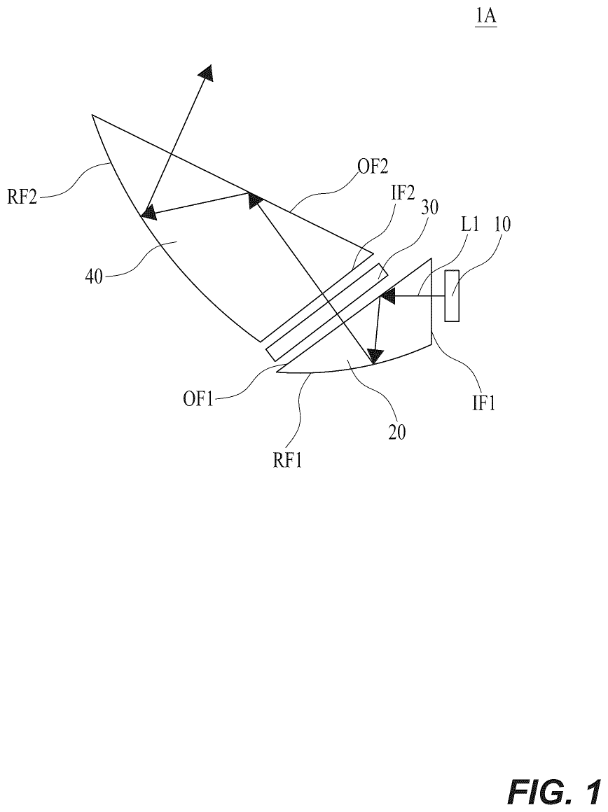

Please refer to FIG. 1, which depicts a configuration diagram of an illumination system according to one embodiment of the present disclosure. As shown in FIG. 1, an illumination system 1A includes a light source 10, a first turning prism 20, a second turning prism 40 and a light homogenizing element 30. The light source 10 is configured to generate a light beam L1. The first turning prism 20 is disposed on the travel path of the light beam L1 from the sources. The second turning prism 40 is disposed on the travel path of the light beam L1 from the first turning prism 20 and guides the light beam L1 with the first turning prism 20. The light homogenizing element 30 is disposed between the first turning prism 20 and the second turning prism 30 and homogenizes the light beam L1.

The light source 10 is a solid-state light source, and for example, the light source 10 may be a LED, a laser diode, etc. In the present embodiment, the light source 10 can emit a plurality of light rays with various colors, and in other words, the light beam encompasses the plurality of light rays with various colors. Specifically, the light source 10 includes a first light emission unit, a second light emission unit and the third light emission unit, and the color of the emitted light from the first light emission unit, the color of the emitted light from the second light emission unit and the color of the emitted light from the third light emission unit are different from each other. For example, the first light emission unit is a red LED, the second light emission unit is a green LED, and third light emission unit is a blue RED. The first light emission unit emits a first light ray according to a first clock frequency, and the second light emission unit emits a second light ray according to a second clock frequency, and the third light emission unit emits a third light ray according to a third clock frequency, and the first clock frequency, the second clock frequency and the third clock frequency are different from each other. Hence, the emission time point of the first light ray, the emission time point of the second light ray and the emission time point of the third light ray are different from each other, and the first light ray, the second light ray and the third light ray are separately emitted in sequence to form the light beam L1. In other words, the first light emission unit, the second light emission unit and the third light emission unit separately emit light according to their corresponding clock frequencies to form the light beam.

The first turning prism 20 is disposed between the light source 10 and the light homogenizing element 30 and is separately disposed with the light source 10 and the light homogenizing element 30. The materials of the first turning prism 20 may include N-BK7 or fused quartz. Furthermore, the first turning prism 20 includes a first light incident surface IF1, a first light output surface OF1 and a first light reflective surface RF1; the first light reflective surface RF1 and the first light output surface OF1 are located on one side of the first light incident surface IF1 facing away from the light source 10. The first light incident surface IF1 faces the light source 10, and the first light incident surface IF1 is vertical to the travel direction of the light beam L1, and the first light incident surface IF1 is a plane. In another embodiment, the first light incident surface IF1 is a spherical surface or a freeform surface. The first light reflective surface RF1 is a spherical reflector with a metal layer; in another embodiment, the first light reflective surface RF1 is a curved surface or the freeform surface with the metal layer. The materials of the metal layer may include Al, Ag or Au, for example. The first light output surface OF1 faces the light homogenizing element 30 and is the plane. In another embodiment, the first light output surface OF1 may be the spherical surface or the freeform surface.

The travel path of the light beam L1 on the first turning prism 20 would be described as follows: the light beam L1 is incident on the first light output surface OF1 from the first light incident surface IF1, and the light beam L1 is reflected and guided to travel to the first light reflective surface RF1 by the first light output surface OF1, and the light beam L1 is reflected and guided to pass through the first light output surface OF1 and be incident on the light homogenizing element 30 by the first light reflective surface RF1.

The light homogenizing element 30 is located on the travel path of the light beam L1 from the first turning prism 20; one side of the light homogenizing element 30 faces the first turning prism 20, and the other side of the light homogenizing element 30 facing away from the first turning prism 20 faces the second turning prism 40. For example, the light homogenizing element 30 may be an optical integrator rod or a lens array. The light homogenizing element 30 is disposed in parallel with the first light output surface OF1. The light homogenizing element 30 receives the light beam L1 from the first turning prism 20 and homogenizes the light beam L1 so that the light intensity distribution of the light beam L1 is uniform, and then, the light homogenizing element 30 guides the homogenized light beam L1 to the second turning prism 40.

The second turning prism 40 is located on the travel path of the light beam L1 from the light homogenizing element 30; the second turning prism 40 and the light homogenizing element 30 are separately disposed, and the materials of the second turning prism 40 may include N-BK7 or fused quartz. Furthermore, the second turning prism 40 includes a second light incident surface IF2, a second light output surface OF2 and a second light reflective surface RF2; the second light reflective surface RF2 and the second light output surface OF2 are located on one side of the second light incident surface IF2 facing away from the light homogenizing element 30. The second light incident surface IF2 faces the light homogenizing element 30 and is disposed in parallel with the light homogenizing element 30. In the present embodiment, the second light incident surface IF2 is the plane; in another embodiment, the second light incident surface IF2 is the spherical surface or the freeform surface. In the present embodiment, the second light reflective surface RF2 is the spherical reflector with the metal layer; in another embodiment, the second light reflective surface RF2 is the curved surface or the freeform surface with the metal layer. In the present embodiment, the second light output surface OF2 is the plane; in another embodiment, the second light output surface OF2 is the spherical surface or the freeform surface.

The travel path of the light beam L1 on the second turning prism 40 would be described as follows: the light beam L1 from the light homogenizing element 30 is incident on the second light output surface OF2 from the second light incident surface IF2, and then the light beam L1 from the light homogenizing element 30 is reflected and guided to travel to the second light reflective surface RF2 by the second light output surface OF2, and then the light beam L1 from the light homogenizing element 30 is reflected and guided to pass through the second light output surface OF2 by the second light reflective surface RF2.

Integrating the travel path of light beam L1 on the first turning prism 20 with the travel path of light beam L1 on the second turning prism 40, the travel path of the light beam L1 on the illumination system 1A would be further described as follows: the light beam L1 is vertically incident on the interior of the first turning prism 20 from the first light incident surface IF1 and travels to the first light output surface OF1, and when the incident angle of the light beam L1 on the first light output surface OF1 meets the critical angle condition of the TIR of the first turning prism 20, the TIR occurs on the first light output surface OF1 to form first incident light, and the first incident light is incident on the first light reflective surface RF1. Due to the metal layer of the first light reflective surface RF1, the first incident light is reflected to form first reflected light by the first light reflective surface RF1, and the first reflected light is incident on the light homogenizing element 30. The light homogenizing element 30 homogenizes the first reflected light to form first uniform light.

Thereafter, the first uniform light is vertically incident on the interior of the second turning prism 40 from the second light incident surface IF2 and travels to the second light output surface OF2, and when the incident angle of the first uniform light on the second light output surface OF2 meets the critical angle condition of the TIR of the second turning prism 40, the TIR occurs on the second light output surface OF2 to form second incident light, and the second incident light is incident on the second light reflective surface RF2. Due to the metal layer of the second light reflective surface RF2, the second incident light is reflected to form second reflected light by the second light reflective surface RF2, and the second reflected light passes through the second light output surface OF2.

In the illumination system of the present embodiment, the two turning prisms are utilized to guide the light beam. Because the optical characteristics of the two turning prisms are different from the optical characteristic of the lens, there is no need to consider the focal length of the lens, the image distance and the particular interval between the two adjacent lenses in the illumination system of the present embodiment, and thus, the light path of the illumination system is shortened, and the configuration of the illumination system is simplified. In addition, the illumination system of the present embodiment may be applied to the micro projector to significantly reduce the volume of the micro projector.

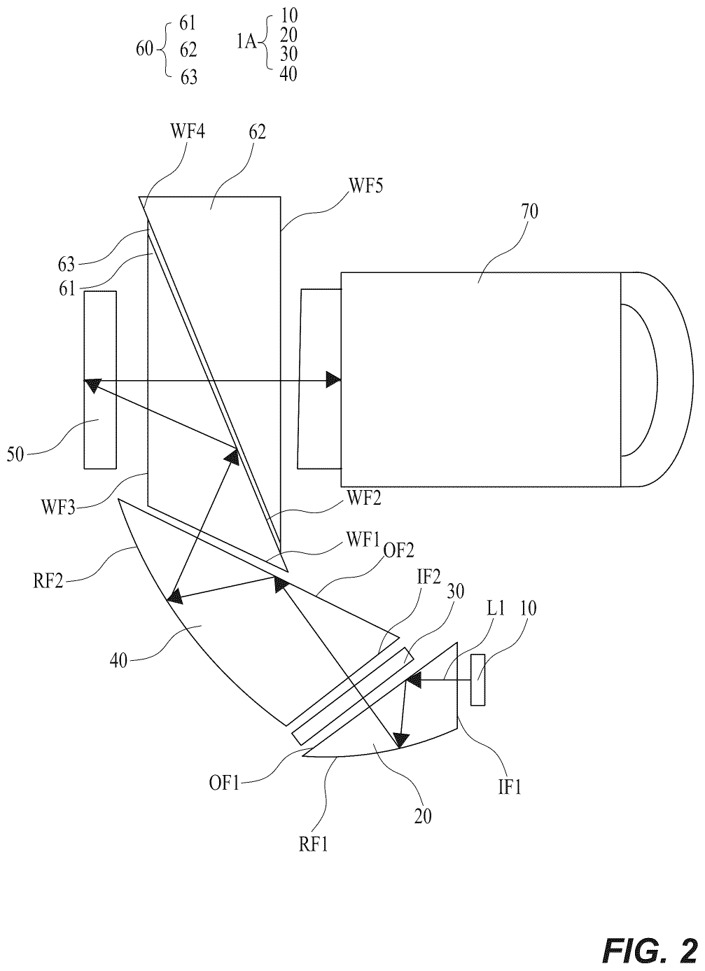

Please refer to FIG. 2, which depicts a configuration diagram of a projection device according to one embodiment of the present disclosure. As shown in FIG. 2, a projection device includes the illumination system 1A, a TIR prism 60, a light valve 50 and a projection lens 70. The illumination system 1A includes the light source 10, the first turning prism 20, the second turning prism 40, and the light homogenizing element 30, and the configuration of the light source 10, the first turning prism 20, the second turning prism 40 and the light homogenizing element 30 is similar to the configuration as shown in FIG. 1 and would not be repeated herein.

The TIR prism 60 is disposed on the travel path of the light beam L1 from the second turning prism 40 and forms an illumination light beam. Specifically, the TIR prism 60 is disposed between the light valve 50 and the projection lens 70, the second turning prism 40 is located between the TIR prism 60 and the light homogenizing element 30, and the TIR prism 60 receives the light beam L1 from the second turning prism 40 and forms and guides the illumination light beam to the light valve 50. Furthermore, the TIR prism 60 includes a first auxiliary prism 61, a second auxiliary prism 62 and an adhesive layer 63, and the first auxiliary prism 61 is attached to the second auxiliary prism 62 by the adhesive layer 63. The materials of the adhesive layer 63 may be Canada Balsam, a prism adhesive, or a UV adhesive.

The first auxiliary prism 61 has a first work surface WF1, a second work surface WF2, and a third work surface WF3. The second work surface WF2 and the third work surface WF3 are disposed on one side of the first work surface WF1 facing away from the second turning prism 40. The first work surface WF1 faces the second light output surface OF2 of the second turning prism 40 and is disposed in parallel with the second light output surface OF2. The second work surface WF2 is an adhesive surface contacting the adhesive layer 63, and in other words, the second work surface WF2 partially overlaps the adhesive layer 63, and the part of the second work surface WF2 which does not overlap the adhesive layer 63 is exposed in the air. The third work surface WF3 faces the light valve 50 and is disposed in parallel with the light valve 50. The first work surface WF1, the second work surface WF2 and the third work surface WF3 are all planes.

The second auxiliary prism 62 has a fourth work surface WF4 and a fifth work surface WF5. The fourth work surface WF4 is disposed on one side of the fifth work surface WF5 facing away from the projection lens 70. The fourth work surface WF4 is the adhesive surface contacting the adhesive layer 63, and in other words, the fourth work surface WF4 partially overlaps the second work surface WF2, and the part of the fourth work surface WF4 which does not overlap the adhesive layer 63 is exposed in the air. The fifth work surface WF5 faces the projection lens 70 and is disposed in parallel with the projection lens 70. The fourth work surface WF4 and the fifth work surface WF5 are all planes.

The travel path of the light beam L1 on the TIR prism 60 would be described as follows: the light beam L1 from the second turning prism 40 is incident on the second work surface WF2 from the first work surface WF1, the light beam L1 is reflected to form the illumination light beam by the second work surface WF2, and the illumination light beam passes through the third work surface WF3 and is incident on the light valve 50.

The light valve 50 is disposed on the travel path of the illumination light beam and converts the illumination light beam into an image light beam, and the image light beam passes through the TIR prism 60 and is incident on the projection lens 70. For example, the light valve 50 is a DMD. Specifically, the light valve 50 receives the illumination light beam passing through the third work surface WF3 from the second work surface WF2, and the illumination light is converted into the image light beam by the micro-lenses on the DMD. The projection lens 70 is disposed on the travel path of the image light beam and receives the image light beam from the TIR prism 60, and appropriately adjusts the image light beam and projects the adjusted image light beam into a screen.

Please refer to FIG. 1 again, and according to the paragraphs corresponding to FIG. 1, the light beam L1 output from the second light output surface OF2 of the second turning prism 40 is the second reflected light. In the following paragraph, the light transmission path between the TIR prism 60, the light valve 50 and the projection lens 70 would be described by the second reflected light and FIG. 2 as follows: the second reflected light is incident on the second work surface WF2 from the first work surface WF1, and when the incident angle of the second reflected light on the second work surface WF2 meets the critical angle condition of the TIR of the first auxiliary prism 61, the TIR occurs on the second work surface WF2 to form the illumination light beam, and the illumination light beam passes through the third work surface WF3 and is incident on the light valve 50. The light valve 50 generates the image light beam according to the illumination light beam, and the image light beam is vertically incident on the interior of the first auxiliary prism 61 from the third work surface WF3 and passes through the second work surface WF2, the adhesive layer 63 and the fourth work surface WF4, and then, the image light beam is incident on the interior of the second auxiliary prism 62 and passes through the fifth work surface WF5 to travel to the projection lens 70.

In the projection device of the present embodiment, the projection device has the advantages of the illumination system to achieve the objective of reducing the volume of the micro projector. In addition, because the two turning prisms are substituted for the combination of the plurality of lenses and the reflector, the configuration of the plurality of lenses and the reflector may decrease, and thus, the objectives of reducing the manufacturing cost of the micro projector and decreasing the assembly tolerances of the micro projector may be achieved.

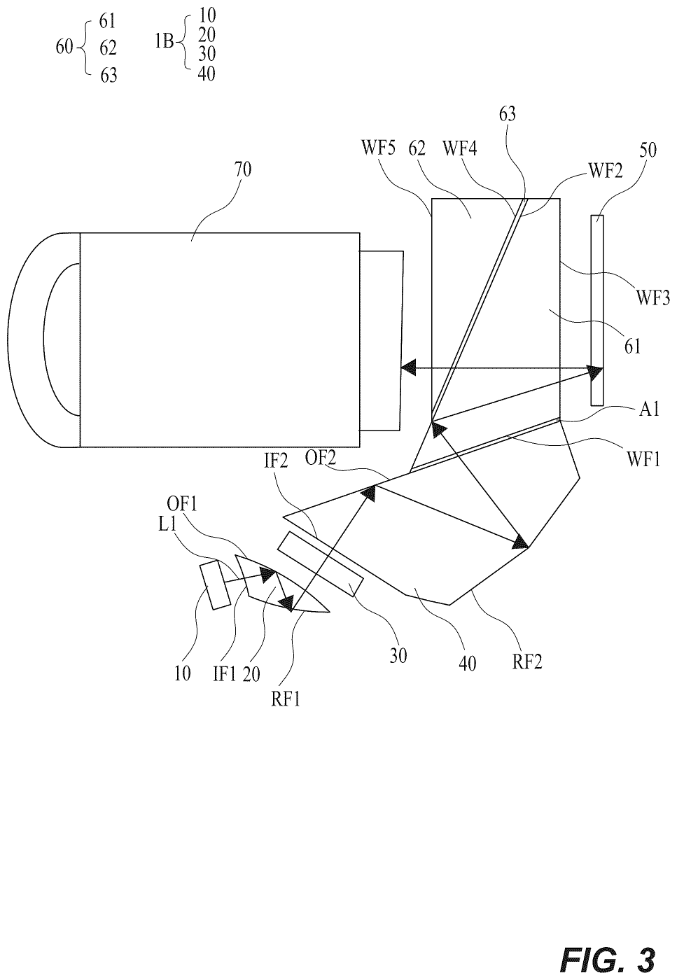

Please refer to FIG. 3, which depicts a configuration diagram of a projection device according to another embodiment of the present disclosure. As shown in FIG. 3, the projection device includes the illumination system 1B, the TIR prism 60, the light valve 50 and the projection lens 70. The illumination system 1B includes the light source 10, the first turning prism 20, the second turning prism 40 and the light homogenizing element 30, and the configuration of the light source 10, the first turning prism 20, the second turning prism 40 and the light homogenizing element 30 is similar to the configuration as shown in FIG. 1 and the similarities between the illumination system 1B and the illumination system 1A would not be repeated herein, but there are still some differences between the illumination system 1B and the illumination system 1A as follows: the first light incident surface IF1 is the spherical surface, the first light output surface OF1 is the freeform surface, and the second turning prism 40 is attached to the TIR prism 60. In addition, the configuration of the TIR prism 60, the light valve 50 and the projection lens 70 has been described in the paragraphs corresponding to FIG. 2 and would not be repeated herein.

The first light incident surface IF1 belonging to the spherical surface facilitates the light beam L1 to focus on the first light output surface OF1. The first light output surface OF1 belonging to the freeform surface improves optical aberration (e.g., spherical aberration or optical distortion). The second light output surface OF2 of the second turning prism 40 and the first work surface WF1 of the first auxiliary prism 61 of the TIR prism 60 are attached to each other by the prism adhesive A1, and the second light output surface OF2 and the first work surface WF1 are all planes so that the adhesion between the second turning prism 40 and the first auxiliary prism 61 would be more successful. Due to the adhesion between the second turning prism 40 and the first auxiliary prism 61, the light beam L1 output from the second light output surface OF2 directly passes through the prism adhesive A1 and travels to the interior of the TIR prism 60 without passing through the air, and the light transmission path between the second turning prism 40 and the TIR prism 60 is significantly shortened.

In the projection device of the present embodiment, because the second turning prism and the TIR prism are attached to each other and guide the light beam by the TIR mechanism, the optical path of the light beam in the air is effectively declined, and the volume of the micro projector may be significantly reduced. When the projection device of the present embodiment combines improvement of a thermal module, the volume of the projection device may be further reduced, thereby achieving the objective of optimizing the volume of the micro projector.

In view of the above description, the illumination system provided by the present disclosure utilizes the two turning prisms and the light homogenizing element to guide and homogenizes the light beam, thereby shortening the light path of the illumination system and ensuring the light uniformity of the light beam.

In view of the above description, the projection device provided by the present disclosure may achieve the objective of reducing the volume of a micro projector by the aforementioned illumination system. In addition, the use of lenses may be declined because the two turning prisms are substituted for the combination of the plurality of lenses and the reflector, and thus, the objective of reducing the volume of the micro projector and decreasing the assembly tolerances of the micro projector may be achieved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a light source, configured to generate a light beam;
a first turning prism, disposed on a travel path of the light beam;
a second turning prism, disposed on a travel path of the light beam from the first turning prism and guiding the light beam with the first turning prism; and
a light homogenizing element, disposed between the first turning prism and the second turning prism and homogenizing the light beam.

2. The illumination system according to claim 1, wherein the first turning prism comprises a first light incident surface, a first light output surface and a first light reflective surface, and the first light output surface and the first light reflective surface are located on one side of the first light incident surface facing away from the light source, and the first light incident surface faces the light source and is a spherical surface, and the first light output surface faces the light homogenizing element and is a plane, a spherical surface or a freeform surface.

3. The illumination system according to claim 2, wherein the light beam is incident on the first light output surface from the first light incident surface, and the first light output surface guides the light beam to travel to the first light reflective surface, and the first light reflective surface guides the light beam to pass through the first light output surface and be incident on the light homogenizing element.

4. The illumination system according to claim 1, wherein the second turning prism comprises a second light incident surface, a second light output surface and a second light reflective surface, and the second light output surface and the second light reflective surface are located on one side of the second light incident surface facing away from the light homogenizing element, and the second light incident surface faces the light homogenizing element and is a freeform surface.

5. The illumination system according to claim 4, wherein the light beam from the light homogenizing element is incident on the second light output surface from the second light incident surface, and the second light output surface guides the light beam to travel to the second light reflective surface, and the second light reflective surface guides the light beam to pass through the second light output surface.

6. The illumination system according to claim 1, wherein the light source comprises a first light emission unit, a second light emission unit and a third light emission unit, and the first light emission unit, the second light emission unit and the third light emission unit separately emit light according to their corresponding clock frequencies to form the light beam.

7. The illumination system according to claim 1, wherein the light homogenizing element is an optical integrator rod or a lens array.

8. A projection device, comprising:
an illumination system, comprising:
a light source, configured to generate a light beam;
a first turning prism, disposed on a travel path of the light beam;
a second turning prism, disposed on a travel path of the light beam from the first turning prism and guiding the light beam with the first turning prism; and
a light homogenizing element disposed between the first turning prism and the second turning prism and diffusing the light beam;
a TIR prism, disposed on a travel path of the light beam from the second turning prism and forming an illumination light beam;
a light valve, disposed on a travel path of the illumination light beam and converting the illumination light beam into an image light beam; and
a projection lens, disposed on a travel path of the image light beam.

9. The projection device according to claim 8, wherein the first turning prism comprises a first light incident surface, a first light output surface and a first light reflective surface, and the first light output surface and the first light reflective surface are located on one side of the first light incident surface facing away from the light source, and the first light incident surface faces the light source and is a spherical surface, and the first light output surface faces the light homogenizing element and is a plane, a spherical surface or a freeform surface.

10. The projection device according to claim 9, wherein the light beam is incident on the first light output surface from the first light incident surface, and the first light output surface guides the light beam to travel to the first light reflective surface, and the first light reflective surface guides the light beam to pass through the first light output surface and be incident on the light homogenizing element.

11. The projection device according to claim 8, wherein the second turning prism comprises a second light incident surface, a second light output surface and a second light reflective surface, and the second light output surface and the second light reflective surface are located on one side of the second light incident surface facing away from the light homogenizing element, and the second light incident surface faces the light homogenizing element and is a freeform surface.

12. The projection device according to claim 11, wherein the light beam from the light homogenizing element is incident on the second light output surface from the second light incident surface, and the second light output surface guides the light beam to travel to the second light reflective surface, and the second light reflective surface guides the light beam to pass through the second light output surface.

13. The projection device according to claim 8, wherein the light source comprises a first light emission unit, a second light emission unit and a third light emission unit, and the first light emission unit, the second light emission unit and the third light emission unit separately emit light according to their corresponding clock frequencies to form the light beam.

14. The projection device according to claim 8, wherein the light homogenizing element is an optical integrator rod or a lens array.

15. The projection device according to claim 8, wherein the second turning prism is attached to the TIR prism.

16. The projection device according to claim 8, wherein the TIR prism comprises a first work surface, a second work surface and a third work surface, and the second work surface and the third work surface are disposed on one side of the first work surface facing away from the second turning prism, and the first work surface faces the second turning prism, and the third work surface faces the light valve.

17. The projection device according to claim 16, wherein the light beam from the second turning prism is incident on the second work surface from the first work surface to form the illumination light beam, and the illumination light beam passes through the third work surface to travel to the light valve, and the light valve converts the illumination light beam into the image light beam, and the image light beam passes through the TIR prism to travel to the projection lens.
